(19) United States
(12) Patent Application Publication
(10) Pub. No.: US 2026/0264780 A1
(43) Pub. Date: Sep. 10, 2026

(54) ROBOT

(71) Applicant: LG ELECTRONICS INC., Seoul (KR)

(72) Inventors: Yongjun KIM, Seoul (KR); Jideok KIM, Seoul (KR); Keunsik NO, Seoul (KR)

(73) Assignee: LG ELECTRONICS INC., Seoul (KR)

(21) Appl. No.: 19/167,762

(22) PCT Filed: May 10, 2023
(86) PCT No.: PCT/KR2023/006314

§ 371 Date: Sep. 22, 2025

(51) Int. Cl. B62D 57/028; B25J 5/00; B25J 19/02; B60R 19/02; B62D 5/04

(52) U.S. Cl. CPC B62D 57/028; B25J 5/007; B25J 19/02; B60R 19/02; B62D 5/04

(57) ABSTRACT

This robot comprises; a robot body; a link assembly connected to the robot body; and a link motor installed on the robot body and connected to the link assembly, wherein the link assembly and the link motor may be provided in plurality, and the plurality of link assemblies include a front link assembly connected to a front portion of the robot body; and a rear link assembly connected to a rear portion of the robot body, wherein the front link assembly and the rear link assembly may partially overlap each other in the left-right direction.

### TECHNICAL FIELD

The present disclosure relates to a robot.

### BACKGROUND ART

A robot is a machine that automatically processes or operates a given task by own capabilities thereof, and the application fields of robots can be generally classified into industrial, medical, space, subsea use, and the like and can be used in various fields.

A robot can pass through a terrain with tall obstacles or steps, and an example of such a robot is a 4-section link mechanism driving system of a 6-wheeled mobile robot capable of climbing stairs, disclosed in Korean Patent No. 10-0458284 B1 (on Nov. 26, 2004, published), and the 4-section link mechanism driving system of a 6-wheeled mobile robot capable of climbing stairs is a wheeled mobile robot having six driving wheels and a bilaterally symmetrical structure, comprising: a first link connecting a first wheel and a second wheel, connected to a body by a joint mechanism, and connected to a second link by a rotary joint; a second link connected to the first link by the rotary joint, connected to a third wheel at the other end, and connected to the third link by the rotary joint; and a third link connected to the second link by the rotary joint, and connected to the body at the other end by the rotary joint.

### DISCLOSURE

### Technical Problem

An object of the present embodiment is to provide a robot capable of reliably climbing obstacles such as curbs and stairs with a simple structure.

An object of the present embodiment is to provide a robot that can be compacted.

### Technical Solution

According to the present disclosure, a robot comprises a robot body; a link assembly connected to the robot body; and a link motor installed on the robot body and connected to the link assembly, wherein a plurality of link assemblies and link motors are provided, and wherein the plurality of link assemblies comprise a front link assembly connected to a front portion of the robot body; and a rear link assembly connected to a rear portion of the robot body, wherein the front link assembly and the rear link assembly may partially overlap each other in a left-right direction.

The front link assembly and the rear link assembly may be spaced apart in the left-right direction.

The robot further may comprise a friction pad disposed on a bottom surface of the robot body.

The robot further may comprise a front bumper disposed on a front lower portion of the robot body.

The robot further may comprise a rear bumper disposed on a rear lower portion of the robot body.

At least one of the plurality of link assemblies may comprise an input link connected to the link motor; a support shaft installed on the robot body; an output link rotatably connected to the support shaft; a floating link rotatably connected to each of the input link and the output link; and a steering motor installed on one of the input link, the output link, and the floating link.

A length of the support shaft of the front link assembly may be different from a length of the support shaft of the rear link assembly.

The output link may have a curved surface formed to avoid the support shaft of an adjacent link assembly.

The floating link may comprise a motor mounter surrounding the steering motor.

At least one of the plurality of link assemblies may comprise a coupler connected to a rotational axis of the steering motor; an upper mounter connected to the coupler; a suspension connected to the upper mount; a lower mounter connected to the suspension; a wheel motor connected to the lower mounter; and a wheel connected to a rotational axis of the wheel motor.

A center trajectory of the wheel and a trajectory of an input rotational axes of the input link and the floating link may be spaced apart from each other.

At least one of the plurality of link assemblies may further comprise a displacement sensor disposed between the upper mounter and the lower mounter for measuring a displacement of the suspension.

The robot further comprises a shaft gear installed on a rotational axis of the link motor; and a rotary encoder installed on the robot body and having an encoder gear meshed with the shaft gear.

The robot further comprises a processor controlling the link motor, the steering motor, and the wheel motor.

When the robot is not in operation, the processor may control the link motor in an off mode in which each wheel of the plurality of link assemblies is spaced apart from a floor.

When the robot climbs stairs, the processor may control the robot in a special mode in which one wheel of the plurality of link assemblies climbs the stairs first.

### Advantageous Effect

According to the present embodiment, the front link assembly and the rear link assembly are partially overlapped in the left-right direction, thereby enabling the robot to be as compact as possible in the front-rear direction.

Additionally, the length of the support shaft of the front link assembly is different from the length of the support shaft of the rear link assembly, allowing for a simple structure that minimizes interference between the front link assembly and rear link assembly.

Furthermore, the curved portion formed on the output link avoids the support shaft of adjacent link assemblies, allowing the front link assembly and rear link assembly to be installed as close together as possible.

Furthermore, the front link assembly and rear link assembly are spaced apart in the left-right direction, minimizing interference between the front link assembly and the rear link assembly.

Furthermore, when the robot is not operating, the wheels of each of the plurality of link assemblies are spaced apart from a floor, minimizing random movement of the robot and ensuring safety.

Furthermore, when the robot climbs stairs, one wheel of the plurality of link assemblies can reach the stairs first, allowing the robot to climb the stairs more easily.

### DESCRIPTION OF DRAWINGS

FIG. 1 illustrates an AI device including a robot according to an embodiment of the present disclosure;

FIG. 2 illustrates an AI server connected to a robot according to an embodiment of the present disclosure;

FIG. 3 illustrates an AI system according to an embodiment of the present disclosure;

FIG. 4 is a perspective view of a robot according to the present embodiment.

FIG. 5 is a perspective view illustrating a steering mechanism and a wheel module according to the present embodiment.

FIG. 6 is a side view illustrating the connecting axis trajectory of an input link and a floating link and the center trajectory of a wheel according to the present embodiment.

FIG. 7 is a side view illustrating an example of a robot according to the present embodiment climbing stairs.

FIG. 8 is a perspective view of a robot according to the present embodiment when not in operation.

FIG. 9 is a plan view illustrating another example of a robot according to the present embodiment climbing stairs.

FIG. 10 is a side view of a robot according to the present embodiment when overcoming an obstacle.

### BEST MODE

Hereinafter, specific embodiments of the present invention will be described in detail with drawings.

Hereinafter, when it is described that an element is “fastened” or “connected” to another element, it may mean that the two elements are directly fastened or connected, or that a third element exists between the two elements and that the two elements are fastened or connected to each other by said third element. On the other hand, when it is described that an element is “directly fastened” or “directly connected” to another element, it may be understood that no third element exists between the two elements.

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot comprises a driving unit may comprise an actuator or a motor and may perform various physical operations such as moving a robot joint. In addition, a movable robot may comprise a wheel, a brake, a propeller, and the like in a driving unit, and may travel on the ground through the driving unit or fly in the air.

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may comprise an input layer, an output layer, and optionally one or more hidden layers. Each layer comprises one or more neurons, and the artificial neural network may comprise a synapse that links neurons to neurons. In the artificial neural network, each neuron may output the function value of the activation function for input signals, weights, and deflections input through the synapse.

Model parameters refer to parameters determined through learning and comprise a weight value of synaptic connection and deflection of neurons. A hyperparameter means a parameter to be set in the machine learning algorithm before learning, and comprises a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning. In the following, machine learning is used to mean deep learning.

Self-driving refers to a technique of driving for oneself, and a self-driving vehicle refers to a vehicle that travels without an operation of a user or with a minimum operation of a user.

For example, the self-driving may comprise a technology for maintaining a lane while driving, a technology for automatically adjusting a speed, such as adaptive cruise control, a technique for automatically traveling along a predetermined route, and a technology for automatically setting and traveling a route when a destination is set.

The vehicle may comprise a vehicle having only an internal combustion engine, a hybrid vehicle having an internal combustion engine and an electric motor together, and an electric vehicle having only an electric motor, and may comprise not only an automobile but also a train, a motorcycle, and the like.

At this time, the self-driving vehicle may be regarded as a robot having a self-driving function.

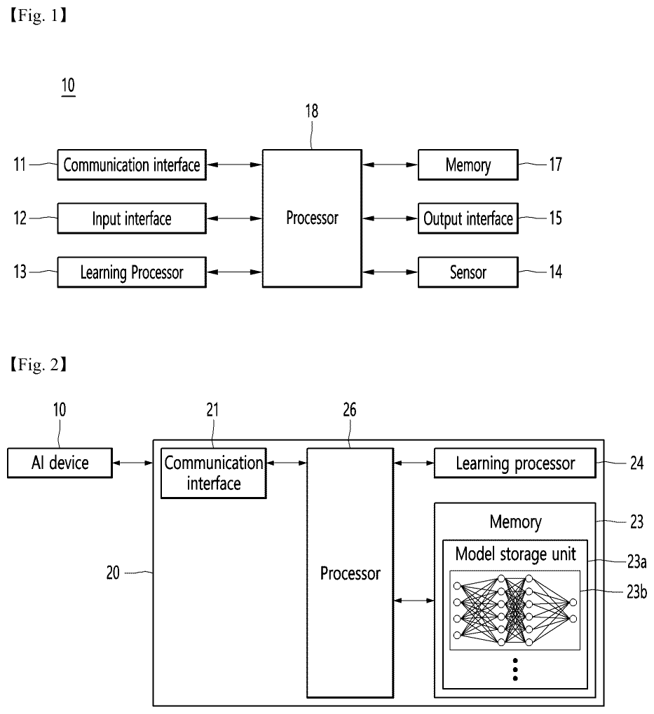

FIG. 1 illustrates an AI device including a robot according to an embodiment of the present disclosure.

The AI device 10 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 10 may comprise a communication interface 11, an input interface 12, a learning processor 13, a sensor 14, an output interface 15, a memory 17, and a processor 18.

The communication interface 11 may transmit and receive data to and from external devices such as other AI devices 10a to 10e and the AI server 20 by using wire/wireless communication technology. For example, the communication interface 11 may transmit and receive sensor information, a user input, a learning model, and a control signal to and from external devices.

The communication technology used by the communication interface 11 comprises GSM (Global System for Mobile communication), CDMA (Code Division Multi Access), LTE (Long Term Evolution), 5G, WLAN (Wireless LAN), Wi-Fi (Wireless-Fidelity), Bluetooth, RFID (Radio Frequency Identification), Infrared Data Association (IrDA), ZigBee, NFC (Near Field Communication), and the like.

The input interface 12 may acquire various kinds of data.

At this time, the input interface 12 may comprise a camera for inputting a video signal, a microphone for receiving an audio signal, and a user input interface for receiving information from a user. The camera or the microphone may be treated as a sensor, and the signal acquired from the camera or the microphone may be referred to as sensing data or sensor information.

The input interface 12 may acquire a learning data for model learning and an input data to be used when an output is acquired by using learning model. The input interface 12 may acquire raw input data. In this case, the processor 18 or the learning processor 13 may extract an input feature by preprocessing the input data.

The learning processor 13 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 13 may perform AI processing together with the learning processor 24 of the AI server 20.

At this time, the learning processor 13 may comprise a memory integrated or implemented in the AI device 10. Alternatively, the learning processor 13 may be implemented by using the memory 17, an external memory directly connected to the AI device 10, or a memory held in an external device.

The sensor 14 may acquire at least one of internal information about the AI device 10, ambient environment information about the AI device 10, and user information by using various sensors.

Examples of the sensors comprised in the sensor 14 may comprise a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output interface 15 may generate an output related to a visual sense, an auditory sense, or a haptic sense.

At this time, the output interface 15 may comprise a display unit for outputting time information, a speaker for outputting auditory information, and a haptic module for outputting haptic information.

The memory 17 may store data that supports various functions of the AI device 10. For example, the memory 17 may store input data acquired by the input interface 12, learning data, a learning model, a learning history, and the like.

The processor 18 may determine at least one executable operation of the AI device 10 based on information determined or generated by using a data analysis algorithm or a machine learning algorithm. The processor 18 may control the components of the AI device 10 to execute the determined operation.

To this end, the processor 18 may request, search, receive, or utilize data of the learning processor 13 or the memory 17. The processor 18 may control the components of the AI device 10 to execute the predicted operation or the operation determined to be desirable among the at least one executable operation.

When the connection of an external device is required to perform the determined operation, the processor 18 may generate a control signal for controlling the external device and may transmit the generated control signal to the external device.

The processor 18 may acquire intention information for the user input and may determine the user's requirements based on the acquired intention information.

The processor 18 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 13, may be learned by the learning processor 24 of the AI server 20, or may be learned by their distributed processing.

The processor 18 may collect history information including the operation contents of the AI apparatus 100 or the user's feedback on the operation and may store the collected history information in the memory 17 or the learning processor 13 or transmit the collected history information to the external device such as the AI server 20. The collected history information may be used to update the learning model.

The processor 18 may control at least part of the components of AI device 10 so as to drive an application program stored in memory 17. Furthermore, the processor 18 may operate two or more of the components comprised in the AI device 10 in combination so as to drive the application program.

FIG. 2 illustrates an AI server connected to a robot according to an embodiment of the present disclosure.

Referring to FIG. 2, the AI server 20 may refer to a device that learns an artificial neural network by using a machine learning algorithm or uses a learned artificial neural network. The AI server 20 may comprise a plurality of servers to perform distributed processing, or may be defined as a 5G network. At this time, the AI server 20 may be comprised as a partial configuration of the AI device 10, and may perform at least part of the AI processing together.

The AI server 20 may comprise a communication interface 21, a memory 23, a learning processor 24, a processor 26, and the like.

The communication interface 21 can transmit and receive data to and from an external device such as the AI device 10.

The memory 23 may comprise a model storage unit 23a. The model storage unit 23a may store a learning or learned model (or an artificial neural network 26b) through the learning processor 24.

The learning processor 24 may learn the artificial neural network 26b by using the learning data. The learning model may be used in a state of being mounted on the AI server 20 of the artificial neural network, or may be used in a state of being mounted on an external device such as the AI device 10.

The learning model may be implemented in hardware, software, or a combination of hardware and software. If all or part of the learning models are implemented in software, one or more instructions that constitute the learning model may be stored in memory 23.

The processor 26 may infer the result value for new input data by using the learning model and may generate a response or a control command based on the inferred result value.

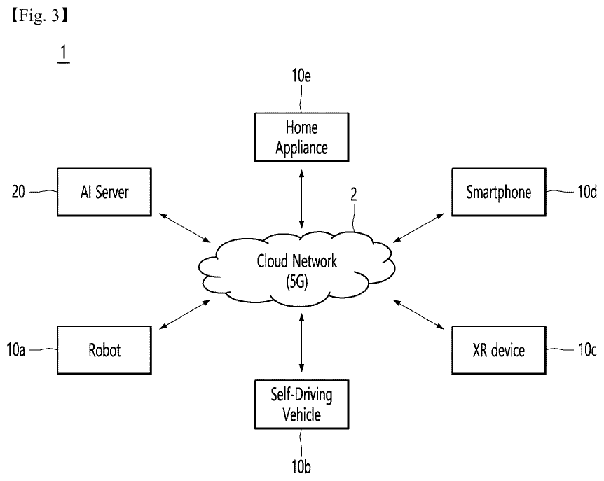

FIG. 3 illustrates an AI system according to an embodiment of the present disclosure.

Referring to FIG. 3, in the AI system 1, at least one of an AI server 20, a robot 10a, a self-driving vehicle 10b, an XR device 10c, a smartphone 10d, or a home appliance 10e is connected to a cloud network 2. The robot 10a, the self-driving vehicle 10b, the XR device 10c, the smartphone 10d, or the home appliance 10e, to which the AI technology is applied, may be referred to as AI devices 10a to 10e.

The cloud network 2 may refer to a network that forms part of a cloud computing infrastructure or exists in a cloud computing infrastructure. The cloud network 2 may be configured by using a 3G network, a 4G or LTE network, or a 5G network.

That is, the devices 10a to 10e and 20 configuring the AI system 1 may be connected to each other through the cloud network 2. In particular, each of the devices 10a to 10e and 20 may communicate with each other through a base station, but may directly communicate with each other without using a base station.

The AI server 20 may comprise a server that performs AI processing and a server that performs operations on big data.

The AI server 20 may be connected to at least one of the AI devices constituting the AI system 1, that is, the robot 10a, the self-driving vehicle 10b, the XR device 10c, the smartphone 10d, or the home appliance 10e through the cloud network 2, and may assist at least part of AI processing of the connected AI devices 10a to 10e.

At this time, the AI server 20 may learn the artificial neural network according to the machine learning algorithm instead of the AI devices 10a to 10e, and may directly store the learning model or transmit the learning model to the AI devices 10a to 10e.

At this time, the AI server 20 may receive input data from the AI devices 10a to 10e, may infer the result value for the received input data by using the learning model, may generate a response or a control command based on the inferred result value, and may transmit the response or the control command to the AI devices 10a to 10e.

Alternatively, the AI devices 10a to 10e may infer the result value for the input data by directly using the learning model, and may generate the response or the control command based on the inference result.

Hereinafter, various embodiments of the AI devices 10a to 10e to which the above-described technology is applied will be described. The AI devices 10a to 10e illustrated in FIG. 3 may be regarded as a specific embodiment of the AI device 10 illustrated in FIG. 1.

The robot 10a, to which the AI technology is applied, may be implemented as a guide robot, a carrying robot, a cleaning robot, a wearable robot, an entertainment robot, a pet robot, an unmanned flying robot, or the like.

The robot 10a may comprise a robot control module for controlling the operation, and the robot control module may refer to a software module or a chip implementing the software module by hardware.

The robot 10a may acquire state information about the robot 10a by using sensor information acquired from various kinds of sensors, may detect (recognize) surrounding environment and objects, may generate map data, may determine the route and the travel plan, may determine the response to user interaction, or may determine the operation.

The robot 10a may use the sensor information acquired from at least one sensor among the lidar, the radar, and the camera so as to determine the travel route and the travel plan.

The robot 10a may perform the above-described operations by using the learning model composed of at least one artificial neural network. For example, the robot 10a may recognize the surrounding environment and the objects by using the learning model, and may determine the operation by using the recognized surrounding information or object information. The learning model may be learned directly from the robot 10a or may be learned from an external device such as the AI server 20.

At this time, the robot 10a may perform the operation by generating the result by directly using the learning model, but the sensor information may be transmitted to the external device such as the AI server 20 and the generated result may be received to perform the operation.

The robot 10a may use at least one of the map data, the object information detected from the sensor information, or the object information acquired from the external apparatus to determine the travel route and the travel plan, and may control the driving unit such that the robot 10a travels along the determined travel route and travel plan.

The map data may comprise object identification information about various objects disposed in the space in which the robot 10a moves. For example, the map data may comprise object identification information about fixed objects such as walls and doors and movable objects such as pollen and desks. The object identification information may comprise a name, a type, a distance, and a position.

In addition, the robot 10a may perform the operation or travel by controlling the driving unit based on the control/interaction of the user. At this time, the robot 10a may acquire the intention information of the interaction due to the user's operation or speech utterance, and may determine the response based on the acquired intention information, and may perform the operation.

The robot 10a, to which the AI technology and the self-driving technology are applied, may be implemented as a guide robot, a carrying robot, a cleaning robot, a wearable robot, an entertainment robot, a pet robot, an unmanned flying robot, or the like.

The robot 10a, to which the AI technology and the self-driving technology are applied, may refer to the robot itself having the self-driving function or the robot 10a interacting with the self-driving vehicle 10b.

The robot 10a having the self-driving function may collectively refer to a device that moves for itself along the given movement line without the user's control or moves for itself by determining the movement line by itself.

The robot 10a and the self-driving vehicle 10b having the self-driving function may use a common sensing method so as to determine at least one of the travel route or the travel plan. For example, the robot 10a and the self-driving vehicle 10b having the self-driving function may determine at least one of the travel route or the travel plan by using the information sensed through the lidar, the radar, and the camera.

The robot 10a that interacts with the self-driving vehicle 10b exists separately from the self-driving vehicle 10b and may perform operations interworking with the self-driving function of the self-driving vehicle 10b or interworking with the user who rides on the self-driving vehicle 10b.

At this time, the robot 10a interacting with the self-driving vehicle 10b may control or assist the self-driving function of the self-driving vehicle 10b by acquiring sensor information on behalf of the self-driving vehicle 10b and providing the sensor information to the self-driving vehicle 10b, or by acquiring sensor information, generating environment information or object information, and providing the information to the self-driving vehicle 10b.

Alternatively, the robot 10a interacting with the self-driving vehicle 10b may monitor the user boarding the self-driving vehicle 10b, or may control the function of the self-driving vehicle 10b through the interaction with the user. For example, when it is determined that the driver is in a drowsy state, the robot 10a may activate the self-driving function of the self-driving vehicle 10b or assist the control of the driving unit of the self-driving vehicle 10b. The function of the self-driving vehicle 10b controlled by the robot 10a may comprise not only the self-driving function but also the function provided by the navigation system or the audio system provided in the self-driving vehicle 10b.

Alternatively, the robot 10a that interacts with the self-driving vehicle 10b may provide information or assist the function to the self-driving vehicle 10b outside the self-driving vehicle 10b. For example, the robot 10a may provide traffic information including signal information and the like, such as a smart signal, to the self-driving vehicle 10b, and automatically connect an electric charger to a charging port by interacting with the self-driving vehicle 10b like an automatic electric charger of an electric vehicle.

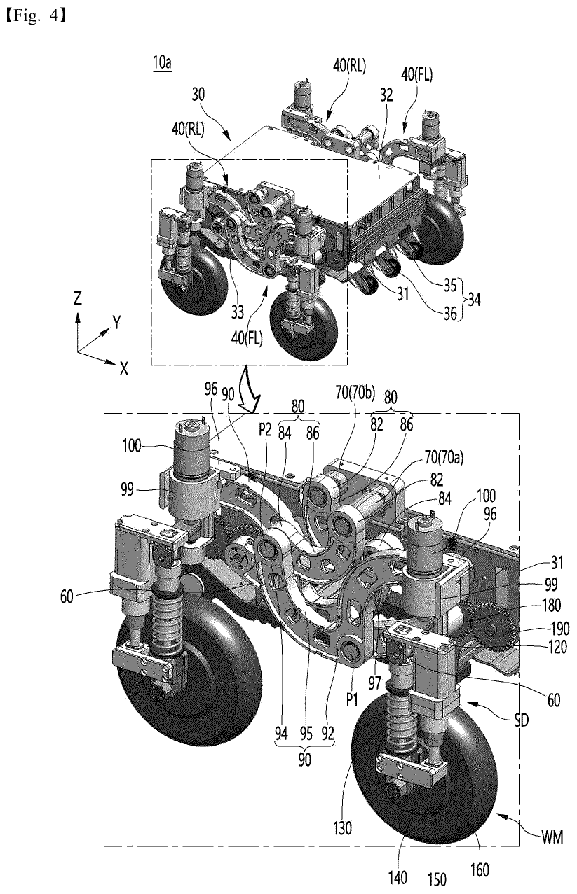

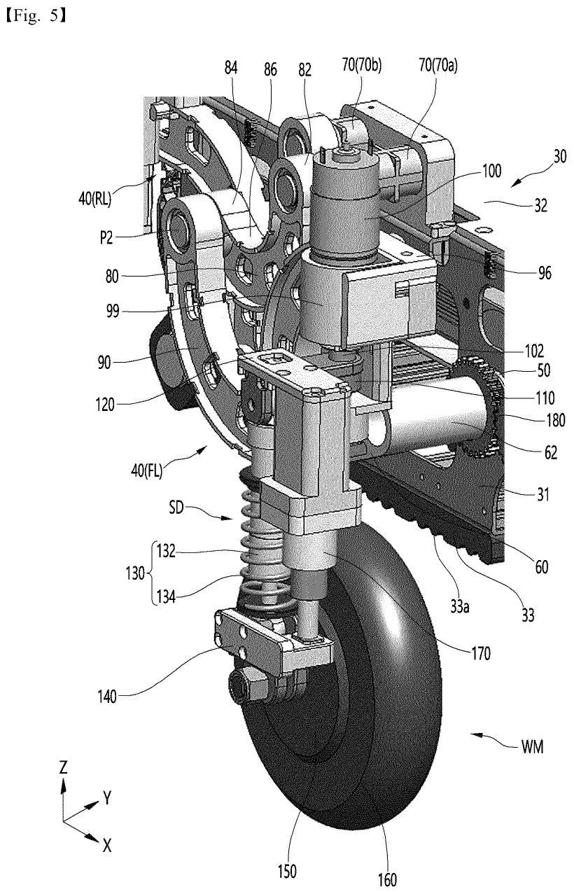

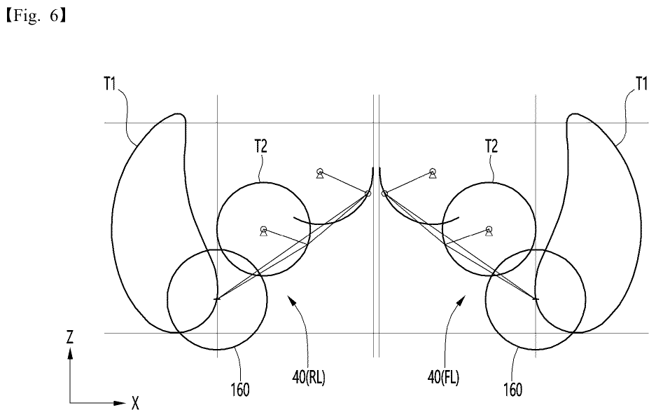

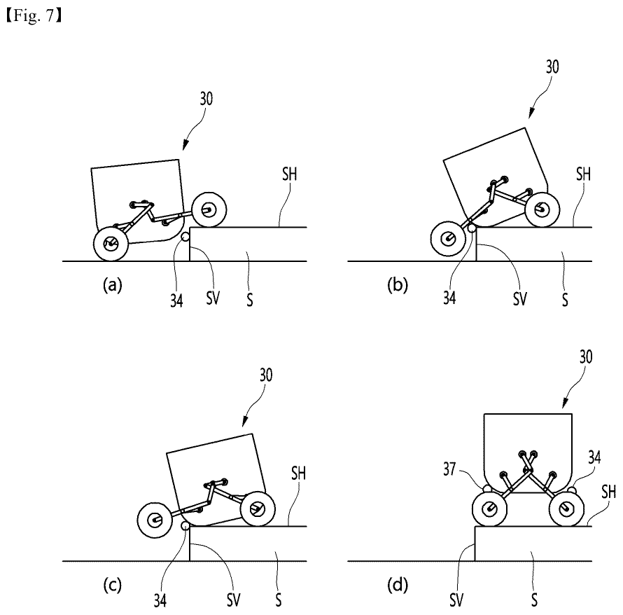

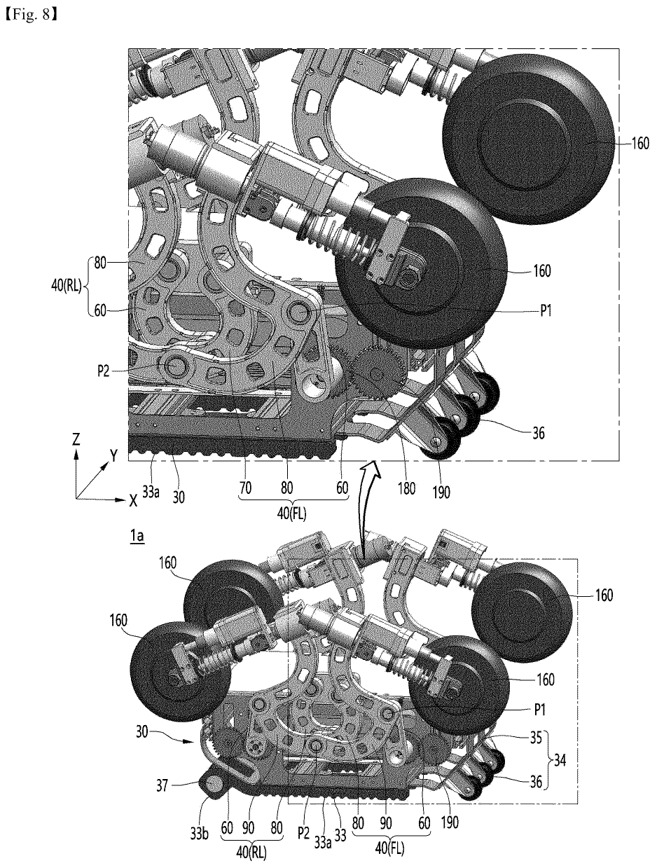

FIG. 4 is a perspective view of a robot according to the present embodiment, FIG. 5 is a perspective view illustrating a steering mechanism and a wheel module according to the present embodiment, FIG. 6 is a side view illustrating the connecting axis trajectory of an input link and a floating link and the center trajectory of a wheel according to the present embodiment, FIG. 7 is a side view illustrating an example of a robot according to the present embodiment climbing stairs and FIG. 8 is a perspective view of a robot according to the present embodiment when not in operation.

The robot 10a may comprise a robot body 30, a link assembly 40, and a link motor 50.

Example of the robot 10a may be a delivery robot capable of transporting various items such as food, cargo, and luggage; a guide robot capable of providing various information to people around the robot 10a and guiding them to specific locations; a security robot for managing facilities such as factories; or an inspection robot for inspecting safety equipment.

The robot body 30 may be composed of a combination of a plurality of components and may be the robot main body.

The robot body 30 may comprise a frame 31 with a space formed therein and a top cover 32 disposed above the frame 31.

The frame 31 may form the bottom surface of the robot body 30.

The top cover 32 may form the top surface of the robot body 30.

A battery may be disposed in the robot body 30, and a processor 18, shown in FIG. 1 connected to the battery may be disposed therein.

The robot 10a may further comprise a friction pad 33, shown in FIG. 5 and FIG. 8.

The friction pad 33 may be disposed on the bottom of the robot body 30.

The friction pad 33 prevents the robot 10a from slipping and may be formed of an elastic material such as rubber. The friction pad 33 may be seated to stairs or other structures hereinafter referred to as “stairs” when the robot 10a ascends or descends stairs.

The upper surface of the friction pad 33 may be attached to the bottom surface of the frame 31.

The bottom surface of the friction pad 33 may be formed with dimples or uneven portions 33a to increase friction with the ground or stairs.

The robot 10a may further comprise a front bumper 34, shown in FIG. 7 and FIG. 8. The front bumper 34 may be disposed at the front lower portion of the robot body 30. The front bumper 34 may comprise a front bracket 35 coupled to the robot body 30 and a roller 36 rotatably disposed on the front bracket 35.

A roller supporter may be formed on the front bracket 35 to rotatably support the roller 36.

The roller 35 may be disposed on the front bracket 35 so as to rotate around a horizontal axis.

A plurality of rollers 35 may be disposed on the front bracket 35. The plurality of rollers 35 may be spaced apart in the left-right direction Y.

When the robot 10a climbs the stairs, the roller 36 of the front bumper 34 may come into contact with the vertical surface SV of the stairs S, as illustrated in FIG. 7 (a), and when the robot 10a climbs the stairs S, it may roll along the vertical surface SV of the stairs S, as illustrated in FIG. 7 (b). The front bumper 34 can help the robot 10a smoothly climb the stairs S while minimizing damage to the robot body 30.

The robot 10a may further comprise a rear bumper 37, shown in FIG. 7 and FIG. 8. The rear bumper 37 may be disposed at the rear lower portion of the robot body 30.

An example of the rear bumper 37 may comprise a rear bracket coupled to the robot body 30 and a roller rotatably disposed on the rear bracket, the roller may be made of an elastic material such as rubber.

Another example of a rear bumper 37 may comprise a roller disposed on a rear bumper installation portion 33b formed on the rear of a rubber pad 33. The roller may be made of an elastic material such as rubber.

A plurality of rollers may be disposed, and the rollers may be disposed spaced apart in the left-right direction Y.

When the robot 10a climbs stairs, the roller of the rear bumper 37 may contact the vertical surface SV of the stairs S or the vertical surface SV and the horizontal surface SH, as illustrated in FIG. 7 (c), when the robot 10a climbs the stairs S, the rear bumper 37 may help the robot 10a smoothly climb the stairs S while minimizing damage to the robot body 30.

The link assembly 40 may comprise wheels 160 that can roll along the ground or climb stairs/curbs, and the link assembly 40 may be a wheel assembly that can function as a driving unit of the robot 10a.

The link assembly 40 may be connected to the robot body 30. The link assembly 40 may be connected to the side of the robot 10a and may be disposed next to the robot body 30.

The link motor 50 may be installed on the robot body 30 and connected to the link assembly 40. The link motor 50 may be installed on the frame 31 and operate the link assembly 40. The link motor 50 may comprise a rotational axis, and the rotational axis of the link motor 50 may be disposed lengthwise in the left-right direction Y, and the rotational center of the link motor 50 may be in the left-right direction Y.

Each of the link assembly 40 and the link motor 50 may be provided in plurality. The link motors 50 may correspond 1:1 with the link assembly 40, and the plurality of link assemblies 40 may be independently operated by the plurality of link motors 50.

The link assemblies 40 may comprise a front link assembly FL connected to the front of the robot body 30 and a rear link assembly RL connected to the rear of the robot body 30.

The front portion of the robot body 30 may be the front portion of the center relative to the center of the robot body 30 in the front-rear direction X, and the front of the robot body 30 may be the rear portion of the center relative to the center of the front-backward direction X.

Each of the front link assembly FL and the rear link assembly RL may be provided in pairs per robot body 30. A pair of front link assemblies FL may be symmetrical left and right with respect to the robot body 30, and a pair of rear link assemblies RL may be symmetrical left and right with respect to the robot body 30.

The plurality of link assemblies 40 may comprise a left front link assembly, a right front link assembly, a left rear link assembly, and a right rear link assembly, and these four link assemblies 40 may operate independently of each other.

Hereinafter, for convenience of explanation, the left front link assembly and the right front link assembly will be referred to as the front link assembly FL, and the left rear link assembly and the right rear link assembly will be referred to as the rear link assembly RL.

Any portion of the front link assembly FL and the rear link assembly RL may overlap partially in the left-right direction Y. In this case, the robot 10a can be compacted in the front-rear direction.

The remain portion of the front link assembly FL and the rear link assembly RL may not overlap partially in the left-right direction Y.

The front link assembly FL and the rear link assembly RL may be spaced apart in the front-rear direction X and the left-right direction Y.

At least one of the plurality of link assemblies 40 may comprise an input link 60, a support shaft 70, an output link 80, a floating link 90, and a steering motor 100. The input link 60 may be connected to the link motor 50.

The input link 60 may be connected to the link motor 50.

The input link 60 may be provided with a connecting portion 62, shown in FIG. 5 for connection to the link motor 50. The connecting portion 62 may be formed to extend in the left-right direction Y and may be connected to the rotational axis of the link motor 50. The connecting portion 62 may be formed to protrude from the input link 60 toward the robot body 30.

When the link motor 50 is driven, the input link 60 may rotate clockwise or counterclockwise around the connecting portion 62.

The input link 60 may be connected to the floating link 90 via an input rotational axis P1, shown in FIG. 4 and FIG. 8. The input rotational axis P1 may be disposed to protrude in the opposite direction of the connecting portion 62.

The input link 60 may be provided with a connecting portion 62 on one longitudinal side and an input rotational axis P1 on the other longitudinal side. The input link 60 may comprise a straight portion formed between the connecting portion 62 and the input rotational axis P1.

The support shaft 70 may be installed on the robot body 30. The support shaft 70 may be disposed horizontally with respect to the robot body 30. The support shaft 70 may be disposed in the left-right direction Y with respect to the robot body 30. The support shaft 70 may be disposed to protrude in the left-right direction Y from a support shaft mounter disposed on the side of the robot body 30.

The height of the support shaft 70 may be higher than the height of the connecting portion 62. The height of the support shaft 70 may be higher than the maximum height of the input rotational axis P1.

The robot 10a can be made more compact when the support shaft 70 of the front link assembly FL and the support shaft 70 of the rear link assembly RL are positioned as close together as possible.

The length of the support shaft of the front link assembly FL and the length of the support shaft of the rear link assembly RL may differ.

Hereinafter, the support shaft of the front link assembly FL will be described as the front support shaft 70a, and the support shaft of the rear link assembly RL will be described as the rear support shaft 70b.

When the lengths of the front support shaft 70a and the rear support shaft 70b differ, the front link assembly FL and the rear link assembly RL can be spaced apart from each other in the left-right direction Y without interfering in the front-back direction X.

If the length of the front support shaft 70a is longer than the length of the rear support shaft 70b, the rear link assembly RL among the front link assembly FL and the rear link assembly RL may be closer to the robot body 30, the rear link assembly RL may be an inner link assembly, and the front link assembly FL may be an outer link assembly.

Conversely, if the length of the rear support shaft 70b is longer than the length of the front support shaft 70a, the front link assembly FL among the front link assembly FL and the rear link assembly RL may be closer to the robot body 30, the front link assembly FL may be an inner link assembly, and the rear link assembly RL may be an outer link assembly.

The output link 80 may be rotatably connected to the support shaft 70.

The output link 80 may be provided with a support shaft connection 82, shown in FIG. 4 and FIG. 5 for connection to the support shaft 70. When the link motor 50 is driven, the support shaft connection 82 may rotate around the support shaft 70.

The output link 80 may rotate clockwise or counterclockwise around the support shaft 70.

The output link 80 may be connected to a floating link 90 via an output rotational shaft P2, shown in FIG. 4 and FIG. 5. The output rotational shaft P2 may be positioned to protrude in the opposite direction from the robot body 30.

The support shaft connection 82 may be provided on one side of the output link 80, and a rotational shaft 84, shown in FIG. 4 and FIG. 5 provided with the output rotational shaft P2 may be positioned on the other side.

The output link 80 may be formed with a curved portion 86, shown in FIG. 4 to avoid the support shaft 70 of an adjacent other link assembly. The curved portion 86 may be formed between the support shaft connecting portion 82 and the rotational shaft portion 84.

The curved portion 86 between the support shaft connecting portion 82 and the rotation shaft portion 84 i.e. may be bent into an arc shape. A cross-sectional shape of the curved portion 86 may be a minor arc shape between the support shaft connecting portion 82 and the rotation shaft portion 84.

The output link 80 may also be formed as a straight portion between the support shaft connecting portion 82 and the rotation shaft portion 84. When the front support shaft 70a and the rear support shaft 70b are positioned close to each other, the output link 80 of the rear link assembly RL may be caught by the front support shaft 70a and interfere with each other, and the output link 80 of the front link assembly FL may be caught by the rear support shaft 70b and interfere with each other.

If the output link 80 of the rear link assembly RL comprises the curved portion 86, the output link 80 of the rear link assembly RL can rotate smoothly while avoiding the front support shaft 70a by the curved portion 86. If the output link 80 of the front link assembly FL comprises the curved portion 86, the output link 80 of the front link assembly FL can rotate smoothly while avoiding the rear support shaft 70b by the curved portion 86.

For the sake of component commonality and assembly convenience, the robot 10 is preferable that the output links 80 of the plurality of link assemblies 40 is formed with the same structure, and it is preferable that the output links 80 of each of the plurality of link assemblies 40 comprise the curved portion 86.

The floating link 90 may be rotatably connected to the input link 60 and the output link 80.

The floating link 90 may be connected to the input link 60 via the input rotational axis P1, and may be connected to the output link 80 via the output rotational axis P2.

The floating link 90 can be moved between the input link 60 and the output link 80.

The floating link 90 may comprise an input rotational shaft connection 92, shown in FIG. 4 to which the input rotational axis P1 is connected, and an output rotational shaft connection 94, shown in FIG. 4 to which the output rotational axis P1 is connected. The floating link 90 may further comprise a steering motor mounting portion 96, shown in FIG. 4 and FIG. 5 to which the steering motor 100 is mounted.

The floating link 90 may comprise a first curved portion 95, like the output link 80. The first curved portion 95 may be formed between the input rotational shaft connection 92 and the output rotational shaft connection 94. A cross-sectional shape of the first curved portion 95 may be an minor arc.

The floating link 90 may comprise a second curved portion 97, shown in FIG. 7, like the output link 80. The second curved portion 97 may be formed between the input rotation shaft connection portion 92 and the steering motor mounting portion 96. A cross-sectional shape of the second curved portion 97 may be a minor arc. The second curved portion 97 may be formed to be convex in the opposite direction of the steering mechanism SD, which will be described later, and may not interfere with the steering mechanism SD when the floating link 90 moves.

The steering motor 100 may be installed in one of the input link 60, the output link 70, and the floating link 90, and is preferably installed in the floating link 90.

The floating link 90 may comprise a motor mounter 99, shown in FIG. 4 and FIG. 5 surrounding the steering motor 100. The mounter 99 may be disposed on the steering motor mounting portion 96, and the steering motor 100 may be mounted on the steering motor mounting portion 96 by the motor mounter 99.

The motor mounter 99 may surround the outer circumference of the steering motor 100.

The center of rotation of the steering motor 100 may be in the vertical direction Z.

The rotational axis 102, shown in FIG. 5 of the steering motor 100 may be disposed lengthwise in the vertical direction Z at the bottom of the steering motor 100.

At least one of the plurality of link assemblies 40 may comprise a coupler 110, an upper mounter 120, a suspension 130, a lower mounter 140, a wheel motor 150, and a wheel 160, as illustrated in FIG. 5. At least one of the plurality of link assemblies 40 may further comprise a displacement sensor 170.

The couplers 110, the upper mounter 120, the suspension 130, and the lower mounter 140 may constitute a suspension mechanism SD, and the wheel motor 150 and the wheel 160 may constitute a wheel module WM mounted on the suspension mechanism SD.

The link assembly 40 may comprise an input link 60, a support shaft 70, an output link 80, a floating link 90, and a steering motor 100, and may further comprise a suspension mechanism SD connected to the steering motor 100, and a wheel module WM connected to the suspension mechanism SD.

The coupler 110 may be connected to the rotational axis 102 of the steering motor 100. The coupler 100 may be rotated forward and reversely about the rotational axis 102 when placed horizontally.

The coupler 110 may transmit the rotational power of the steering motor 100 to the upper mounter 120.

One side of the coupler 110 may comprise a rotational shaft connection portion to which a rotational shaft 102 is connected, and the other side of the coupler 110 may comprise an upper mounter connection portion connected to the upper mounter 120.

The upper mounter 120 may be connected to the coupler 110. The upper mounter 120 may be coupled to the coupler 110 using a fastening member such as a screw, and may rotate forward and reversely together with the coupler 110. The upper mounter 120 may form the upper surface of the suspension mechanism SD.

The suspension 130 may be connected to the upper mounter 120. The suspension 130 may be disposed between the upper and lower mounters 140. The suspension 130 can support the weight of the robot body 30 and minimize vibrations transmitted to the wheels from being transmitted to the robot body 30.

The suspension 130 may comprise a suspension shaft 132 and a spring 134 surrounding the outer circumference of the suspension shaft 132.

The suspension shaft 132 may be mounted on the upper mounter 120 and may be disposed lengthwise in the vertical direction Z.

The upper portion of the spring 134 may be connected to the suspension shaft 132, and the lower portion of the spring 134 may be connected to the lower mounter 140.

The lower mounter 140 may be connected to the suspension 130. The lower mounter 140 may be provided with a shaft hole into which a suspension shaft 132 can be inserted. The lower mounter 140 can support the suspension 130, especially the suspension 130 on the lower side of the spring 134.

The wheel motor 150 may be connected to the lower mounter 140. The wheel motor 150 may be fastened to the lower portion of the lower mounter 140 using a fastening member.

The rotational axis of the wheel motor 150 may be disposed horizontally, and the center of rotation of the wheel motor 150 may be in the left-right direction Y.

The wheel 160 may be connected to the rotational axis of the wheel motor 150.

The wheel motor 150 and the wheel 160 may form an in-wheel motor.

The displacement sensor 170 may be disposed between the upper mounter 120 and the lower mounter 140. The displacement sensor 170 may measure the displacement of the suspension 130.

The displacement sensor 170 may comprise a shaft disposed on the lower mounter 140 and a sensor unit disposed on the sensor case to sense the shaft. When the robot 10a moves, the heights of the upper mounter 120 and the sensor case may vary, and the sensor unit may sense the distance from the shaft.

The robot 10a may further comprise a shaft gear 180 and a rotary encoder 190, as illustrated in FIG. 4 and FIG. 8.

One example of the shaft gear 180 may be installed on the rotational axis of the link motor 50. When the rotational axis of the link motor 50 rotates, the shaft gear 180 may rotate along with the rotational axis of the link motor 50.

Another example of the shaft gear 180 may be installed on the connection portion 62 of the input link 60.

If the rotation axis of the link motor 50 rotates, the connection portion 62 of the input link 60 may rotate together with the rotation axis of the link motor 50, and the shaft gear 180 may rotate together with the connection portion 62 of the input link 60.

The rotary encoder 190 may be installed on the robot body 30. The rotary encoder 190 can have an encoder gear meshed with the shaft gear 180.

The rotary encoder 190 can sense the angular velocity of the shaft gear 180 by the rotation of the encoder gear.

The processor 18 can control the link motor 50, the steering motor 100, and the wheel motor 150.

The robot 10a can lift the wheel 160 onto a curb or stairs, and may comprise a 4-bar linkage to adjust the trajectory T1 of the wheel 160 to suit the curb/stairs condition.

The robot 10a may comprise a 4-bar linkage, which may comprise an input link 60, an output link 80, a floating link 90, and a ground link.

The ground link may be formed by a support shaft 70, a motor body 30, and a link motor 50. The ground link may connect the input link 60 connected to the rotational axis of the link motor 50 and the output link 80 connected to the support shaft 70.

If the robot 10a comprises the 4-bar linkage, each link assembly 40 may have one degree of freedom, minimizing the number of required motors.

When the link motor 50 rotates the input link 60, the wheel 160, connected to the floating link 90 via a suspension mechanism SD and steering motor 100, may move in a trajectory T1, shown in FIG. 6 resembling a water droplet, a half-moon, or a ginkgo leaf.

The link assembly 40 may move the wheel 160 in a trajectory resembling a water droplet, a half-moon, or a ginkgo leaf T1, shown in FIG. 6, enabling the robot to ascend and descend curbs and stairs with minimal degrees of freedom.

As illustrated in FIG. 6, the central trajectory T1 of the wheel 160 and the trajectory T2 of the input rotation axis P1 of the input link 60 and floating link 80 may be spaced apart from each other. The central trajectory T1 of the wheel 160 may resemble a crescent moon or a ginkgo leaf, enabling the robot 10a to overcome curbs and stairs.

Due to the trajectory of the four-bar linkage, the height of the wheel 160 may be adjusted, allowing the robot 10a to maintain the horizontality of the robot body 30 on slopes and to travel stably even on uneven terrain.

When the robot 10a is not in operation, the processor 18 may control the link motor 50 in off mode.

The off mode is a mode in which the robot 10a is not moving, but is in standby or stationary mode. As illustrated in FIG. 8, this is a mode in which the wheels 160 of each of the plurality of link assemblies 40 are spaced apart from the floor.

In the off mode, the robot body 30 or friction pad 33 contacts the floor, and arbitrary movement of the robot 10a may be restricted.

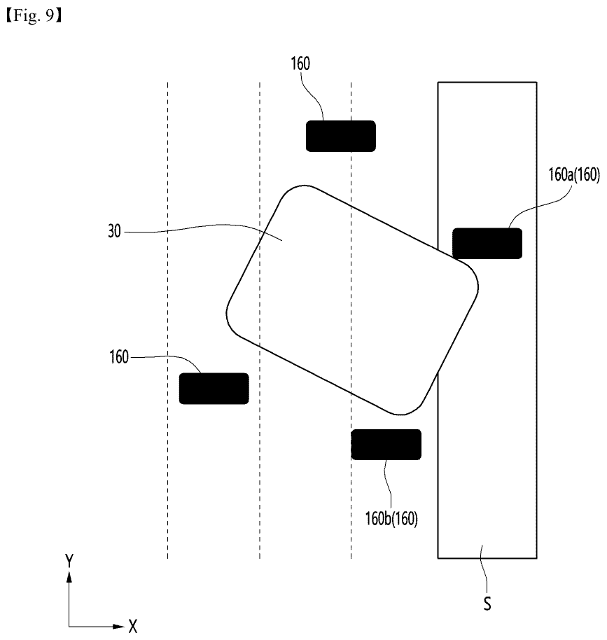

FIG. 9 is a plan view illustrating another example of a robot climbing stairs according to the present embodiment.

When the robot 10a climbs stairs, the processor 18 may control the robot in a special mode.

Here, the special mode may be a mode in which, as illustrated in FIG. 9, one wheel 160 of the plurality of link assemblies 40 climbs the stairs S first.

The special mode may be a crab driving mode in which the robot 10a can climb stairs diagonally, similar to the driving pattern of a crab.

In the special mode, the processor 18 controls the link motor 50 of one of the pair of front link assemblies FL e.g., the left front link assembly to an ascending mode and then controls it again to a descending mode, so that the wheel 160a of one of the pair of front link assemblies FL e.g., the left front link assembly may be placed on the step S before the wheel 160b of the other link assembly e.g., the right front link assembly.

Thereafter, the processor 18 may control the link motor 50 of the other link assembly e.g., the right front link assembly in an ascending mode, and then control it again in a descending mode, and can raise the wheel 160 of the other link assembly e.g., the right front link assembly onto the stairs S.

In the special mode, the robot 10a can sequentially raise the wheels 160a, 160b onto the stairs S, and the robot can easily climb the stairs S.

The robot 10a can maintain the balance of the robot body 30 while overcoming an obstacle by using the links during the special mode.

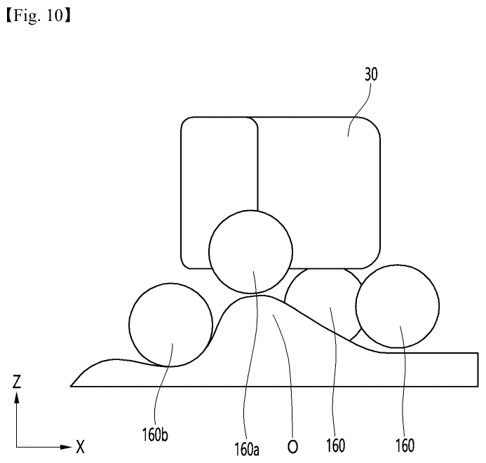

FIG. 10 is a side view of the robot according to the present embodiment when it overcomes an obstacle.

In the driving mode of the robot 10a, only some wheels 160a of the plurality of link assemblies 40 can encounter the obstacle O, and the remaining wheels of the plurality of link assemblies 40 may not encounter an obstacle O.

For example, the suspension mechanism SD of the link assembly 40 that encounters an obstacle O may be compressed, causing the wheel 160 to climb onto the obstacle O. Afterward, the wheel 160 that has climbed onto the obstacle O may climb over the obstacle O, and the compressed suspension mechanism SD may be restored.

As the other example, the link motor 50 of the link assembly 40 that encounters an obstacle O may be controlled to raise the wheel 160a, causing the wheel 160 that encounters the obstacle O to climb onto the obstacle O. Afterward, when the wheel 160 has climbed over the obstacle O, the link motor 50 of the link assembly 40 that has raised the wheel 160 may be controlled to lower the wheel 160.

As described above the robot 10a can overcome the obstacle O while maintaining the robot body 30 horizontally as a whole, even if some of the wheels 160a of the plurality of link assemblies 40 encounter an obstacle.

The above description is merely illustrative of the technical spirit of the present disclosure, and various modifications and changes can be made by those of ordinary skill in the art, without departing from the scope of the present disclosure.

Therefore, the embodiments disclosed in the present disclosure are not intended to limit the technical spirit of the present disclosure, but are intended to explain the technical spirit of the present disclosure. The scope of the technical spirit of the present disclosure is not limited by these embodiments.

The scope of the present disclosure should be interpreted by the appended claims, and all technical ideas within the scope equivalent thereto should be construed as falling within the scope of the present disclosure.

1. A robot comprising:
a robot body;
a link assembly connected to the robot body; and
a link motor installed on the robot body and connected to the link assembly,
wherein a plurality of link assemblies and link motors are provided, and
wherein the plurality of link assemblies comprise:
a front link assembly connected to a front portion of the robot body; and
a rear link assembly connected to a rear portion of the robot body,
wherein the front link assembly and the rear link assembly partially overlap each other in a left-right direction.

2. The robot of claim 1,
wherein the front link assembly and the rear link assembly are spaced apart in the left-right direction.

3. The robot of claim 1, further comprising;
a friction pad disposed on a bottom surface of the robot body.

4. The robot of claim 1, further comprising;
a front bumper disposed on a front lower portion of the robot body.

5. The robot of claim 1, further comprising;
a rear bumper disposed on a rear lower portion of the robot body.

6. The robot of claim 1,
wherein at least one of the plurality of link assemblies comprises:
an input link connected to the link motor;
a support shaft installed on the robot body;
an output link rotatably connected to the support shaft;
a floating link rotatably connected to each of the input link and the output link; and
a steering motor installed on one of the input link, the output link, and the floating link.

7. The robot of claim 6,
wherein a length of the support shaft of the front link assembly is different from a length of the support shaft of the rear link assembly.

8. The robot of claim 6,
wherein the output link has a curved surface formed to avoid the support shaft of an adjacent link assembly.

9. The robot of claim 6,
wherein the floating link comprises a motor mounter surrounding the steering motor.

10. The robot of claim 6,
wherein at least one of the plurality of link assemblies comprises:
a coupler connected to a rotational axis of the steering motor;
an upper mounter connected to the coupler;
a suspension connected to the upper mount;
a lower mounter connected to the suspension;
a wheel motor connected to the lower mounter; and
a wheel connected to a rotational axis of the wheel motor.

11. The robot of claim 10,
wherein a center trajectory of the wheel and a trajectory of an input rotational axes of the input link and the floating link are spaced apart from each other.

12. The robot of claim 10,
wherein at least one of the plurality of link assemblies further comprises:
a displacement sensor disposed between the upper mounter and the lower mounter for measuring a displacement of the suspension.

13. The robot of claim 10, further comprising;
a shaft gear installed on a rotational axis of the link motor; and
a rotary encoder installed on the robot body and having an encoder gear meshed with the shaft gear.

14. The robot of claim 10, further comprising;
a processor controlling the link motor, the steering motor, and the wheel motor.

15. The robot of claim 14,
wherein the processor controls the link motor in an off mode in which each wheel of the plurality of link assemblies is spaced apart from a floor, when the robot is not in operation.

16. The robot of claim 14,
wherein the processor controls the robot in a special mode in which one wheel of the plurality of link assemblies climbs stairs first, when the robot climbs the stairs.
